(19) United States
(12) Patent Application Publication
(10) Pub. No.: US 2016/0178561 A1
(43) Pub. Date: Jun. 23, 2016

(54) HAND-HELD TEST METER WITH TEST STRIP ELECTRODE TO GROUND-REFERENCE SWITCH CIRCUIT BLOCK

(71) Applicant: LifeScan Scotland Limited, Inverness (GB)

(72) Inventors: Malcolm HAMER, Inverness (GB); Jonathan NELSON, Inverness (GB)

(21) Appl. No.: 14/615,745

(22) Filed: Feb. 6, 2015

Related U.S. Application Data
(60) Provisional application No. 62/093,043, filed on Dec. 17, 2014.

(51) Int. Cl. G01N 27/327

(52) U.S. Cl. CPC G01N 27/3273; G01N 27/3271; G01N 27/3272

(57) ABSTRACT

A hand-held test meter for use with an electrochemical-based analytical test strip in the determination of an analyte (such as glucose) in a bodily fluid sample (for example, a whole blood sample) includes a housing, a micro-controller disposed in the housing, a test strip electrode to ground-reference switch circuit block disposed in the housing, a strip port connector configured for operational insertion of an electrochemical-based analytical test strip with an electrode (e.g., a reference electrode), and a ground-reference. In addition, the test strip electrode to ground-reference switch circuit block is configured to be in electrical communication with an electrode of an electrochemical-based analytical test strip inserted in the strip port connector. Moreover, the test strip electrode to ground-reference switch circuit block is configured to connect and disconnect the electrode of the inserted electrochemical-based analytical test strip to the ground-reference under operational control of the micro-controller.

### CROSS REFERENCE TO RELATED APPLICATIONS

This application relates to U.S. patent application Ser. No. 62/093,043, filed Dec. 17, 2014; all applications are herein incorporated by reference in their entireties.

### BACKGROUND OF THE INVENTION

1. Field of the Invention

The present invention relates, in general, to medical devices and, in particular, to test meters and related methods.

2. Description of Related Art

The determination (e.g., detection and/or concentration measurement) of an analyte in, or characteristic of, a bodily fluid sample is of particular interest in the medical field. For example, it can be desirable to determine glucose, ketone bodies, cholesterol, lipoproteins, triglycerides, acetaminophen, haematocrit and/or HbA1c concentrations in a sample of a bodily fluid such as urine, blood, plasma or interstitial fluid. Such determinations can be achieved using a hand-held test meter in combination with analytical test strips (e.g., electrochemical-based analytical test strips).

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings, in which like numerals indicate like elements, of which:

FIG. 1 is a simplified depiction of a hand-held test meter according to an embodiment of the present invention with a test strip (TS) inserted therein;

FIG. 2 is a simplified block diagram of various blocks of the hand-held test meter of FIG. 1 as well as an inserted test strip (TS);

FIG. 3 is another simplified block diagram of various blocks of the hand-held test meter of FIG. 1 as well as an inserted test strip TS;

FIG. 4 is a simplified electrical schematic of a test strip electrode to ground-reference switching circuit block (essentially within the dashed line of FIG. 5) as can be employed in embodiments of the present invention;

FIG. 5 is a simplified electrical schematic model diagram employed to illustrate beneficial electrical characteristics of embodiments of the present invention;

FIG. 6 is a graph of signal magnitude percentage versus Rvar in FIG. 5 illustrating a beneficial capability of hand-held test meters according to embodiments of the present invention; and

FIG. 7 is a flow diagram depicting stages in a method for operating a hand-held test meter according to an embodiment of the present invention.

### DETAILED DESCRIPTION OF ILLUSTRATIVE EMBODIMENTS

The following detailed description should be read with reference to the drawings, in which like elements in different drawings are identically numbered. The drawings, which are not necessarily to scale, depict exemplary embodiments for the purpose of explanation only and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein.

In general, hand-held test meters for use with an electrochemical-based analytical test strip in the determination of an analyte (such as glucose) in, and/or a characteristic (for example, hematocrit) of, a bodily fluid sample (such as for example, a whole blood sample) according to embodiments of the present invention include a housing, a micro-controller disposed in the housing, a test strip electrode to ground-reference switch circuit block disposed in the housing, a strip port connector configured for the operational insertion of an electrochemical-based analytical test strip, the electrochemical-based analytical test strip having at least one electrode (such as at least one reference/ground electrode), and a ground/reference. In addition, the test strip electrode to ground-reference switch circuit block is in electrical communication with the at least one electrode of an electrochemical-based analytical test strip inserted into the strip port connector via the strip port connector. Moreover, the test strip electrode to ground-reference switch circuit block is configured to connect and disconnect the at least one electrode of an inserted electrochemical-based analytical test strip to the ground-reference under operational control of the micro-controller.

A deleteriously high electrical resistance between a reference electrode of an electrochemical-based analytical test strip and a meter's ground-reference can adversely affect analyte determination by the hand-held test meter. Such a deleteriously high electrical resistance, therefore, results in an operationally inadequate connection between the reference electrode and the ground-reference. Hand-held test meters according to embodiments of the present invention are beneficial in that a comparison of an electrical measurement (e.g., an impedance measurement) made with the at least one electrode connected to the ground-reference and an electrical measurement (such as an open circuit impedance measurement) made with the at least one electrode disconnected from ground-reference can be employed to determine if an operationally adequate connection exists when the at least one electrode is connected to the meter reference-ground.

In addition, test strip electrode to ground-reference switch circuit blocks according to embodiments of the present invention are a cost effective way to detect a poor (i.e., operationally inadequate) reference electrode connection. Once detected, the meter's micro-controller can, for example, prevent the display of any determination results to a user and display an appropriate alert message (e.g., an error message) to such user.

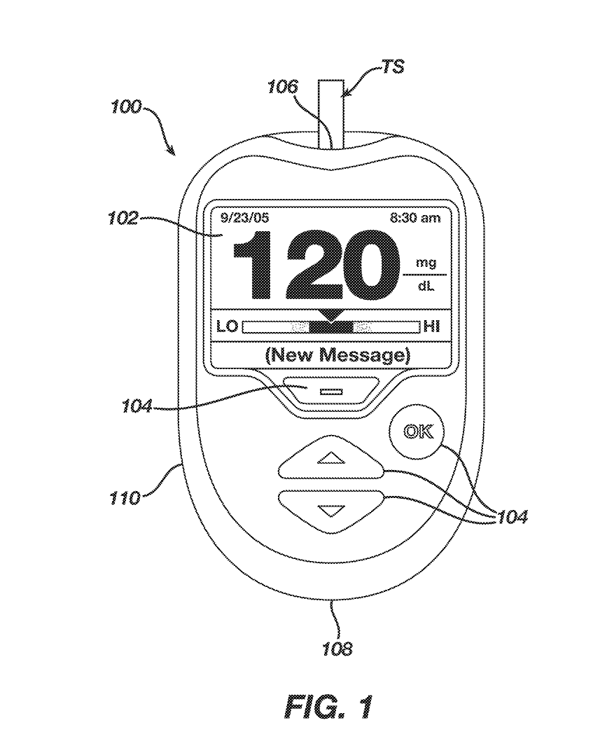

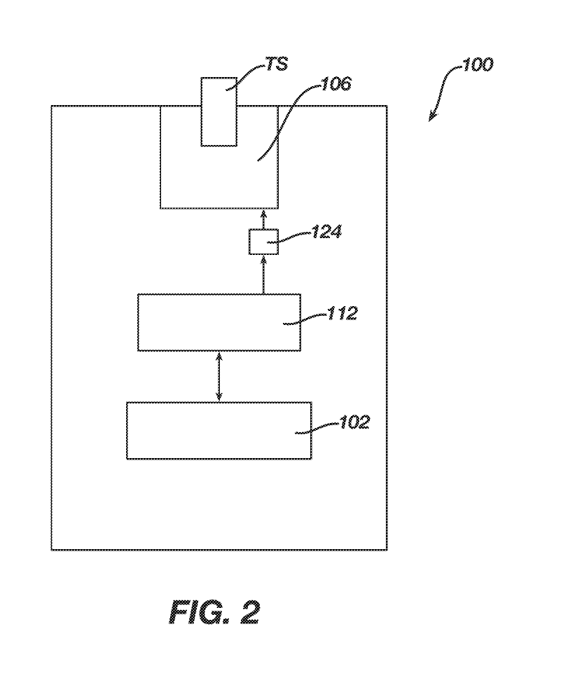

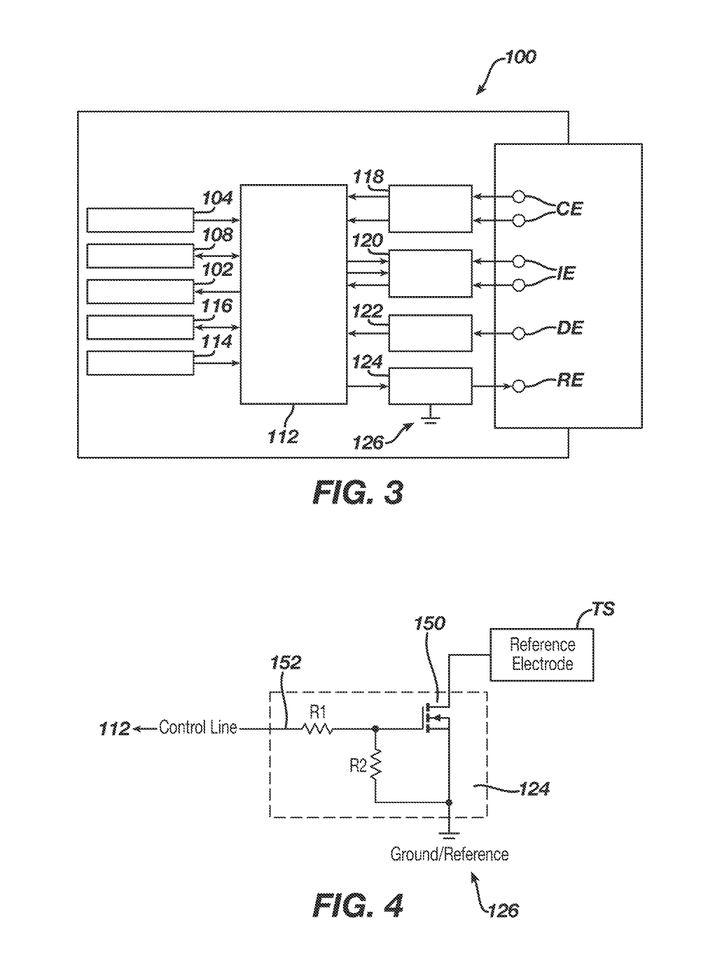

FIG. 1 is a simplified depiction of a hand-held test meter 100 for the determination of an analyte in, and/or a characteristic of, a bodily fluid sample according to an embodiment of the present invention. FIG. 2 is a simplified block diagram of various blocks of hand-held test meter 100 and a test strip (TS). FIG. 3 is another simplified block diagram of various blocks of hand-held test meter of 100 and electrical connections between a micro-controller of the hand-held test meter and various electrodes of test strip TS. FIG. 4 is a simplified electrical schematic of a test strip electrode to ground-reference switching circuit block (essentially within the dashed line of FIG. 4) as can be employed in embodiments of the present invention.

Referring to FIGS. 1 through 4, hand-held test meter 100 includes a display 102, a plurality of user interface buttons 104, a strip port connector 106, a USB interface 108, and a housing 110 (see FIG. 1). Referring to FIGS. 2 and 3 in particular, hand-held test meter 100 also includes a micro-controller block 112, a battery 114, a memory circuit block 116, a current measurement circuit block 118, an impedance measurement circuit block 120, a strip detect circuit block 122, a test strip electrode to ground-reference switch circuit block 124, a meter ground-reference 126 and other electronic components (not shown in the FIGs.) for applying an electrical bias (e.g., an alternating current (AC) and/or direct current (DC) bias) to an electrochemical-based analytical test strip (labeled TS in FIGS. 1, 2 and 3), and also for measuring an electrochemical response (e.g., plurality of test current values, phase, and/or magnitude) and determining an analyte or characteristic based on the electrochemical response. To simplify the current descriptions, the figures do not depict all such electronic circuitry.

Referring to FIG. 3 in particular, test strip (TS) includes two electrodes configured for current measurements (each labeled CE in FIG. 3), two electrodes configured for impedance measurements (each labeled IE in FIG. 3), a single electrode configured to enable strip detection (labeled DE in FIG. 3) and a reference electrode (labeled RE in FIG. 3).

Display 102 can be, for example, a liquid crystal display or a bi-stable display configured to show a screen image. An example of a screen image during the determination of an analyte in a bodily fluid sample may include a glucose concentration, a date and time, an error message, and a user interface for instructing a user how to perform a test. Examples of screen images during use of the operating range test strip simulation circuit block may be an image reporting that a hand-held test meter operating range test passed, or an image reporting that the hand-held test meter operating range test has resulted in an error.

Strip port connector 106 is configured to operatively interface with an electrochemical-based analytical test strip TS, such as an electrochemical-based analytical test strip configured for the determination of hematocrit and/or glucose in a whole blood sample. Therefore, the electrochemical-based analytical test strip is configured for operative insertion into strip port connector 106 and to operatively interface with micro-controller block 112 via, for example, suitable electrical contacts, wires, electrical interconnects or other structures known to one skilled in the art.

USB Interface 108 can be any suitable interface known to one skilled in the art. USB Interface 108 is an electrical component that is configured to power and provide a data line to hand-held test meter 100.

Micro-controller block 112 also includes a memory sub-block that stores suitable algorithms for the determination of an analyte based on the electrochemical response of an analytical test strip and to also determine a characteristic (e.g., hematocrit) of the introduced bodily fluid sample. Micro-controller block 112 is disposed within housing 110 and can include any suitable micro-controller and/or micro-processer known to those skilled in the art. Suitable micro-controllers include, but are not limited to, micro-controllers available commercially from Texas Instruments (Dallas, Tex., USA) under the MSP430 series of part numbers; from ST MicroElectronics (Geneva, Switzerland) under the STM32F and STM32L series of part numbers; and Atmel Corporation (San Jose, Calif., USA) under the SAM4L series of part numbers).

Meter ground-reference 126 can be any suitable meter ground-reference known to one skilled in the art. For example, a meter ground-reference can be a ground reference employed by the hand-held test meter's power supply such as a battery's negative terminal.

Referring to FIGS. 3 and 4 in particular, test strip electrode to ground-reference switch circuit block 124 is configured such that it is in electrical communication with the at least one electrode of an electrochemical-based analytical test strip inserted in the strip port connector (for example, a reference electrode as labeled in FIG. 4). Moreover, test strip electrode to ground-reference switch circuit block 124 is configured to connect and disconnect at least one electrode of an inserted electrochemical-based analytical test strip to the ground-reference under operational control of the micro-controller.

Test strip electrode to ground-reference switch circuit blocks employed in embodiments of the present invention can be any suitable switch circuit block. In the embodiment of FIG. 4, test strip electrode to ground-reference switch circuit block 124 includes N-type FET transistor 150, control line 152 and two resistors (R1 and R2). When control line 152 is pulled to a high state by micro-controller 112, the reference electrode will be connected to ground-reference via transistor 150 (albeit such connection can be either operationally adequate or operationally inadequate depending on the condition and state of other components of hand-held test meter 100). However, when control line 152 is pulled low (e.g., to zero volts) by micro-controller 112, the reference electrode will be disconnected from the meter's ground-reference.

N-type FET transistor 150 can be any suitable transistor known to one skill in the art including, for example, N-type FET transistors commercially available from NXP Semiconductor, Eindhoven, The Netherlands. Exemplary, but non-limiting, resistance values for resistors R1 and R2 are 10 k-ohm and 100 k-ohm respectively.

Once apprised of the present disclosure, one skilled in the art will recognize that test strip electrode to ground-reference circuit blocks employed in embodiments of the present invention can take various forms and are not limited to the embodiment depicted in FIG. 4. For example, alternative test strip electrode to ground-reference switch electrical circuit blocks could be a suitable electromechanical switch that is configured for control by the micro-controller block or an analog switch (such as the analog switch available from NXP Semiconductor as part number 74LVC1G3157GW).

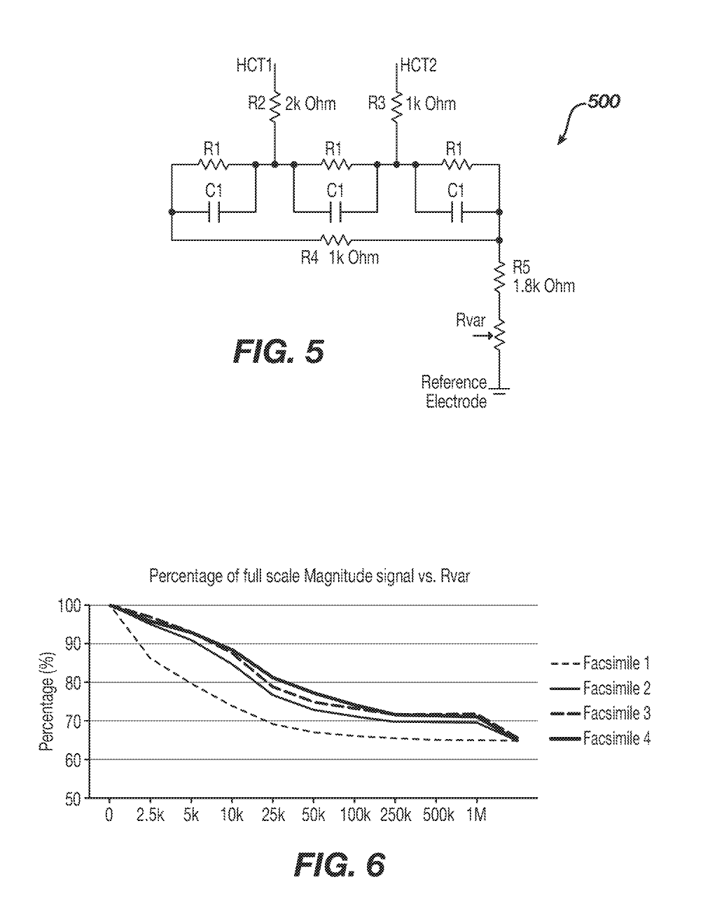

FIG. 5 is a simplified electrical schematic model diagram of a test circuit 500 employed to illustrate beneficial electrical characteristics of embodiments of the present invention as described further with respect to FIG. 6. FIG. 6 is a graph of signal magnitude percentage versus Rvar in FIG. 5 illustrating a feature of hand-held test meters according to embodiments of the present invention. The data of FIG. 6 was experimentally determined using the circuit of FIG. 5.

In test circuit 500, a combination of R1 and C1 is employed as an electrical model of a whole blood sample, while R2, R3, R4, and R5 are representations of the fixed resistances of an exemplary electrochemical-based analytical test strip. Rvar is the representation of the connection of a reference electrode of the electrochemical-based analytical test strip to the meter's ground-reference. Rvar at zero ohms represents a good (i.e., operationally adequate) connection. Rvar at essentially infinity, i.e., an open circuit, represents the worst case operationally inadequate connection.

A test was conducted to determine the relative magnitude of a measured signal with Rvar between zero ohms and greater than 1 million ohms (i.e., open circuit). The tests were done at four different impedance loads (referred to as facsimiles in FIG. 6) across between the electrodes labeled HCT1 and HCT2 in FIG. 5. Facsimile 1 employed a load of 21,257 ohms, Facsimile 2 a load of 40,734 ohms, Facsimile 3 a load of 47,532 ohms and Facsimile 4 a load of 66,966 ohms.

In these tests, the magnitude of the measured impedance signal always decreased to approximately 65% of the magnitude at a Rvar of 0 ohms. Based on the knowledge that an open circuit measurement also referred to as ImpFinal) is 65% of the full scale impedance, it is possible to back calculate the impedance measurement (referred to as ImpCalc) that would be made with a 0 ohm reference electrode to meter GND (Impinit).

During use of a hand-held test meter according to an embodiment of the present invention, in the event that Impinit (i.e., an impedance measured with the hand-held test meter's reference electrode connected to a ground-reference) does not match the calculated ImpCalc within 5%, an error has been detected as there is an operationally inadequate connection between the reference electrode and the meter's ground-reference. Alternatively, a first measurement with a connection to ground-reference and a second measurement made with a disconnected ground-reference can be analyzed using a predetermined threshold that has been experimentally or theoretically determined for a given combination of hand-held test meter and electrochemical-based analytical test strip. For example, the predetermined threshold could be that the first measurement must be at least a suitable percentage greater than the second measurement.

Once apprised of the present disclosure, one skilled in the art will recognize that that embodiments of the present invention can be readily configured by modification of the hand-held test meters described in co-pending Great Britain Patent Application No. 1303616.5, filed on Feb. 28, 2013, which is hereby incorporate in full by reference.

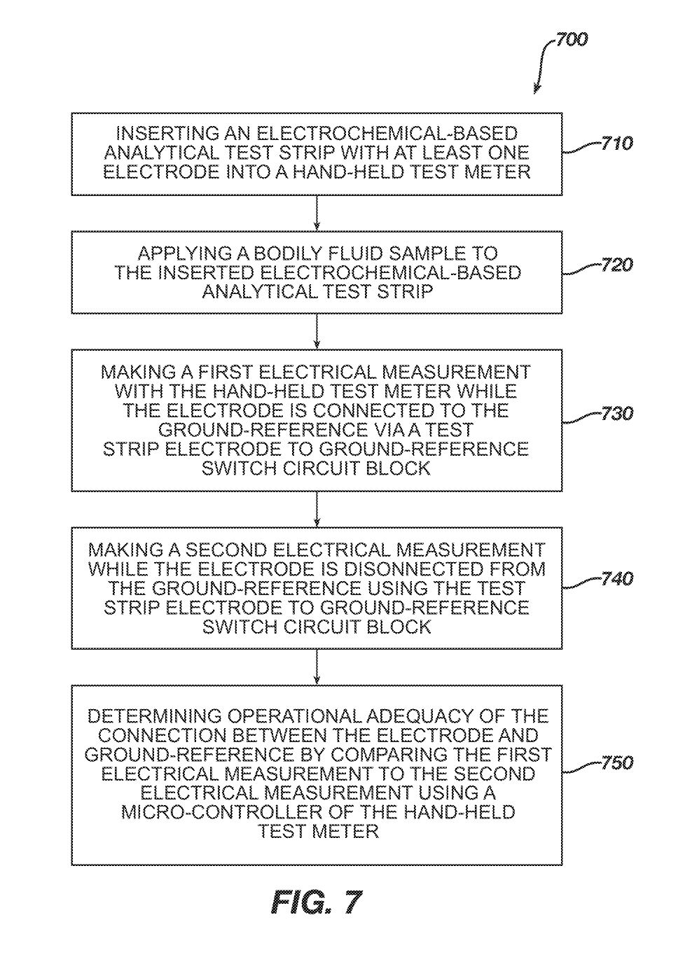

FIG. 7 is a flow diagram depicting stages in a method 700 for employing a hand-held test meter (e.g., hand-held test meter 100 of FIG. 1) for use with an electrochemical-based analytical test strip for the determination of an analyte in, and/or a characteristic of, a bodily fluid sample (e.g., a whole blood sample), according to an embodiment of the present invention. A non-limiting example of such an analyte is glucose in a whole blood sample. A non-limiting example of such a characteristic is hematocrit of a whole blood sample.

Method 700 includes employing inserting an electrochemical-based analytical test strip with at least one electrode into a hand-held test meter (see step 710 of FIG. 7). Referring to step 720, subsequently a bodily fluid sample, such as a whole blood sample, is applied to the inserted electrochemical-based analytical test strip.

At step 730, a first electrical measurement is made with the hand-held test meter while the at least one electrode of the inserted electrochemical-based analytical test strip is connected to a ground-reference of the hand held test meter via a test strip electrode to ground-reference switch circuit block. Once apprised of the present disclosure, one skilled in the art will recognize that such a connection between the at least one electrode (such as a reference electrode) and the reference-ground may be operationally adequate (for example, an electrical connection of suitably low electrical resistance) or may be operationally inadequate (for example, an electrical connection of unsuitably high resistance or an electrically open connection). Operationally inadequate electrical connections between the at least one electrode and the ground-reference are deleterious in that they can result in inaccurate or otherwise faulty analyte determinations. Hence, it is beneficial for a hand-held test meter and associated methods to be able to detect whether a connection is operationally adequate or operationally inadequate.

At step 740, a second electrical measurement is made with the hand-held test meter while the at least one electrode of the inserted electrochemical-based analytical test strip is disconnected from the ground-reference of the hand held test meter using the test strip electrode to ground-reference switch circuit block.

It is particularly beneficial when the first electrical measurement and second electrical measurement of methods according to embodiments of the present invention are impedance measurements since the magnitude of impedance measurements are particularly sensitive to the lack of connection to a ground-reference and high-resistance connections to a ground-reference.

Once apprised of the present disclosure, one skilled in the art will recognize that, if desired, the order of making the first electrical measurement and the second electrical measurement can be reversed from that depicted in FIG. 7.

In step 750 of method 700, operational adequacy of the connection between the inserted electrochemical-based analytical test strip and the ground-reference is determined by comparing the first electrical measurement to the second electrical measurement using a micro-controller of the hand-held test meter.

Once apprised of the present disclosure, one skilled in the art will recognize that methods according to embodiments of the present invention, including method 700, can be readily modified to incorporate any of the techniques, benefits and characteristics of hand-held test meters according to embodiments of the present invention and described herein.

Once apprised of the present disclosure, one skilled in the art will recognize that the meters and methods according to embodiments of the present invention, including method 700, can employ any suitable electrochemical techniques, including those based on Cottrell current measurements, coulometry, amperometry, chronoamperometry, potentiometry, and chronopotentiometry.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that devices and methods within the scope of these claims and their equivalents be covered thereby.

What is claimed is:

1. A hand-held test meter for use with an electrochemical-based analytical test strip in the determination of an analyte in a bodily fluid sample, the hand-held test meter comprising:
a housing;
a micro-controller disposed in the housing;
a test strip electrode to ground-reference switch circuit block disposed in the housing;
a strip port connector configured for the operational insertion of an electrochemical-based analytical test strip, the electrochemical-based analytical test strip having at least one electrode; and
a ground-reference,
wherein the test strip electrode to ground-reference switch circuit block is in electrical communication with the at least one electrode of an electrochemical-based analytical test strip inserted in the strip port connector; and
wherein the test strip electrode to ground-reference switch circuit block is configured to connect and disconnect the at least one electrode of an inserted electrochemical-based analytical test strip to the ground-reference under operational control of the micro-controller.

2. The hand-held test meter of claim 1 configured to make a first electrical measurement with the at least one electrode of a received electrochemical-based analytical test strip connected to the ground-reference via the test strip electrode to ground-reference switch circuit block and to make a second electrical measurement with the at least one electrode disconnected from the ground-reference by the test strip electrode to ground-reference switch circuit block.

3. The hand-held test meter of claim 2 configured to make an analyte determination measurement of a bodily fluid sample applied to the inserted electro-chemical-based analytical test strip.

4. The hand-held test meter of claim 2 wherein the first electrical measurement is a first impedance measurement and the second electrical measurement is a second impedance measurement.

5. The hand-held test meter of claim 2 further including:
a display,
and wherein the hand-held test meter is configured to make an analyte determination measurement of a bodily fluid sample applied to the inserted electro-chemical-based analytical test strip and, thereafter, to display a result of the analyte determination measurement to a user if a predetermined threshold comparison of the first electrical measurement and the second electrical measurement has been achieved.

6. The hand-held test meter of claim 5 wherein the hand-held test meter is configured to display an alert message to a user if the predetermined threshold comparison has not been achieved.

7. The hand-held test meter of claim 1 wherein the at least one electrode is at least one electrode configured as a reference electrode.

8. The hand-held test meter of claim 1 wherein the test strip electrode to ground-reference switch circuit block includes:
a transistor in series between the at least one electrode and the ground-reference; and
a control signal line configured for electrical communication between the micro-controller and the test strip electrode to ground-reference.

9. The hand-held test meter of claim 1 wherein the test strip electrode to ground-reference switch circuit block includes an electromechanical switch.

10. The hand-held test meter of claim 1 wherein the test strip electrode to ground-reference switch circuit block includes an analog switch.

11. The hand-held test meter of claim 1 wherein the electrochemical-based analytical test strip is an electrochemical-based analytical test strip configured for the determination of glucose in a whole blood bodily fluid sample. 12 The hand-held test meter of claim 9 wherein the electrochemical-based analytical test strip is an electrochemical-based analytical test strip configured for the determination of glucose in a whole blood bodily fluid sample and hematocrit of the whole blood bodily fluid sample.

13. A method for employing a hand-held test meter for use with an electrochemical-based analytical test strip in the determination of an analyte in a bodily fluid sample, the method comprising:
inserting an electrochemical-based analytical test strip with at least one electrode into a hand-held test meter;
applying a bodily fluid sample to the inserted electrochemical-based analytical test strip;
making a first electrical measurement with the hand-held test meter while the at least one electrode of the inserted electrochemical-based analytical test strip is connected to a ground-reference of the hand held test meter via a test strip electrode to ground-reference switch circuit block;
making a second electrical measurement with the hand-held test meter while the at least one electrode of the inserted electrochemical-based analytical test strip is disconnected from the ground-reference of the hand held test meter using the test strip electrode to ground-reference switch circuit block; and
determining operational adequacy of the connection between the inserted electrochemical-based analytical test strip and the meter ground-reference by comparing the first electrical measurement to the second electrical measurement using the micro-controller of the hand-held test meter.

14. The method of claim 13 further including,
determining at least one of an analyte in and a characteristic of a bodily fluid sample applied to the analytical test strip using a micro-controller of the hand-held test meter.

15. The method of claim 13 wherein the first electrical measurement is a first impedance measurement and the second electrical measurement is a second impedance measurement.

16. The method of claim 13 further including,
displaying a result of the analyte determination measurement to a user if a predetermined threshold comparison of the first electrical measurement and the second electrical measurement has been achieved.

17. The method of claim 14 further including,
displaying an alert message to a user if a predetermined threshold comparison of the first electrical measurement and the second electrical measurement has not been achieved.

18. The method of claim 17 wherein the predetermined threshold is based on a percentage difference between the first electrical measurement and the second electrical measurement.

19. The method of claim 13 wherein the at least one electrode is at least one electrode configured as a reference electrode.

20. The method of claim 13 wherein the test strip electrode to meter ground-reference switch circuit block includes:
a transistor in series between the at least one electrode and the meter ground/reference; and
a control signal line configured for electrical communication between the micro-controller and the test strip electrode to meter ground/reference.
